(19) United States
(12) Patent Application Publication
(10) Pub. No.: US 2020/0393244 A1
(43) Pub. Date: Dec. 17, 2020

(54) Line level Pro

(71) Applicants: matthew thomas sorg, guyton, GA (US); jennifer marie sorg, guyton, GA (US)

(72) Inventors: matthew thomas sorg, guyton, GA (US); jennifer marie sorg, guyton, GA (US)

(21) Appl. No.: 16/575,326

(22) Filed: Nov. 5, 2019

(51) Int. Cl. G01C 9/06; H04R 1/02; H04R 3/00; G08B 7/06; G08B 21/18

(52) U.S. Cl. CPC G01C 9/06; H04R 1/028; H04R 3/00; G01C 2009/066; G08B 21/182; H04R 2420/07; G08B 7/06

(57) ABSTRACT

The Line Level Pro is a great new tool that can be used in any trade in America. You simply attach the device to any string, cable or rope that you may be working with. While moving your line up or down the device will beep in different speeds depending on how far/close the device is to being in the level position. This device is also equipped with a three light L.E.D. system that emits three different lights depending on how far/close the device is to being level. As a bonus the device will come with Bluetooth capabilities.

### CROSS-REFERENCE TO RELATED APPLICATIONS

No application has been previously filed for this invention.

### STATEMENT REGARDING FEDERALLY SPONSORED RESEARCH OR DEVELOPMENT

N/A

### REFERENCE TO A SEQUENCE LISTING, A TABLE, OR A COMPUTER PROGRAM, LISTING COMPACT DISC APPENDIX

N/A

### BACKGROUND OF THE INVENTION

The history of line levels is basic system you hang the level on the string, cable, etc. and watch for the bubble to come in between two lines to know its level, which normally would require more than two workers on certain jobs. With This Product Line Level Pro takes the line level into the next century. By being equipped with audio beeping to indicate when device is far/close to being at a level state. It will also accommodate the hearing impaired with a three light signal system that works on the same basis as the beeping system. The device will also be Bluetooth equipped.

### BRIEF SUMMARY OF THE INVENTION

Line Level Pro is a revolutionary product, while using a beeping mechanism to let the consumer know when the level has reached a level position. It also has a three light L.E.D. visual system for consumers who may be hearing impaired. It makes a three-man job a one-man job.

### BRIEF DESCRIPTION OF THE SEVERAL VIEWS OF THE DRAWING

As seen on attached page, below is a description of each function that will be offered.

FIG. 1. front view of which shows the L.C.D. screen and bubbles.

FIG. 2. Side view displaying the three-colors of the beeping system.

FIG. 3. Top view showing the hooks that will be used to attach Line Level Pro to the string.

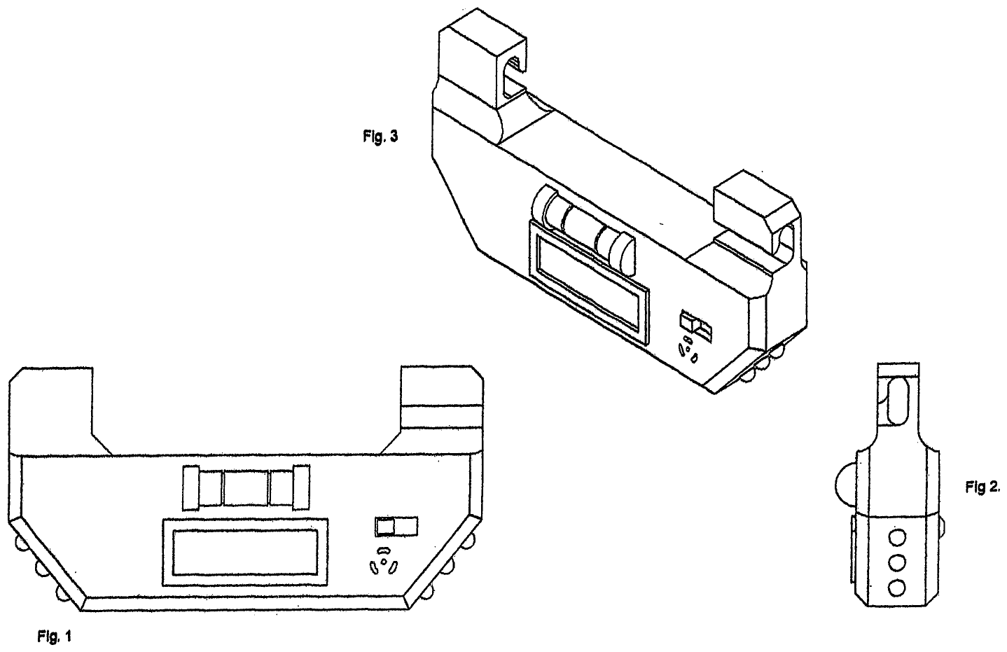

### DETAILED DESCRIPTION OF THE INVENTION

This invention can be used in virtually any trade in America. To use Line Level Pro, one would simply hang the device from a string, cable, etc. with the attached hooks as seen in FIG. 3. When properly attached move the line up and down, device will begin to beep with different speeds depending on how close or far away the device is from being level. There will also be three signals shown in FIG. 2. That will light up on indication of how level the device is.

1. What we claim as our invention is a Beeping Line Level comprising:
A. Built in speaker which provides audio signal to the user in form of repeated beeping.
B. Multi-color L.E.D. signal that allows a visual signal that the device is far, near, or within level range.
C. Equipped with Bluetooth technology in the event the user would need to hear through an earpiece.
